(19) United States
(12) Patent Application Publication
(10) Pub. No.: US 2025/0019781 A1
(43) Pub. Date: Jan. 16, 2025

(54) METHODS FOR PRODUCING FERROUS ALLOYS IN METALLURGICAL FURNACES

(71) Applicant: Pipex Energy S.r.l., Milano (MI) (IT)

(72) Inventors: Luca OREFICI, Angera (VA) (IT); Carlo MAPELLI, Vailate (CR) (IT)

(21) Appl. No.: 18/719,130

(22) PCT Filed: Dec. 15, 2022
(86) PCT No.: PCT/IB2022/062279

§ 371 Date: Jun. 12, 2024

(30) Foreign Application Priority Data
Dec. 15, 2021 (IT) 102021000031460

(51) Int. Cl. C21B 5/02

(52) U.S. Cl. CPC C21B 5/026

(57) ABSTRACT

A method for producing a ferrous alloy may include: melting a ferrous metal charge in a metallurgical furnace to obtain a mass of molten metal; and feeding into the metallurgical furnace, before, during, and/or after the melting of the ferrous metal charge, at least one granular composite material including: greater than or equal to 50% and less than or equal to 97% by weight of a polymeric component including polyethylene; and greater than or equal to 3% and less than or equal to 50% by weight of metallic aluminum. The percentages by weight refer to a total weight of the polymeric component including polyethylene and the metallic aluminum.

### FIELD OF THE INVENTION

The present invention relates to a method for producing a ferrous alloy in a metallurgical furnace. In particular, the present invention relates to a method for producing a ferrous alloy in a metallurgical furnace characterized by a reduced environmental impact.

### BACKGROUND OF THE INVENTION

As is well known, ferrous alloys, e.g., steel or cast iron, are produced starting from ferrous materials, such as metal ore or ferrous scrap, in metallurgical furnaces of various types (e.g., electric arc furnaces, converter blast furnaces, furnaces, etc.). In metallurgical furnaces, the starting ferrous materials are treated at high temperature (about 1300-2000° C.) until a molten metal mass is obtained, which is then refined to obtain the desired chemical composition for the final alloy and then solidified.

In the various steps of the ferrous alloy production process, carbon sources, i.e., materials containing carbon, are used with different functions, e.g., as chemical energy sources (fuels), reducing agents, foaming slag-forming agents, etc.

The most commonly used carbon sources are of fossil origin, such as anthracite, metallurgical coke, calcined petroleum coke, char and graphite. For example, in the case of electric arc furnace (EAF) steel-making processes, the carbon sources are either charged as fuel together with the ferrous material to be melted or are injected during the melting step of the ferrous material, or are injected into the molten metal bath and into the slag to reduce the iron oxides and/or promote the formation of a foamy slag so as to increase the energy efficiency of the process, limit electrode consumption, protect the refractory material of the furnace and the panels cooled by forced circulation of water.

However, the use of materials of fossil origin in metallurgical furnaces has a significant environmental impact due to the high amounts of climate-changing emissions, mainly CO₂, generated by the oxidation of these materials.

In order to limit the environmental impact, it is known in the prior art to use carbon-containing polymeric materials obtained from the recovery of waste, such as plastic and rubber, as a partial replacement of fossil carbon sources. In fact, the polymeric materials consist of long polymeric chains containing mainly carbon and hydrogen atoms and can therefore provide thermal energy during the melting process or act as reducing agents in the molten metal bath. The use of these materials also has the advantage of valorizing waste and scrap from industrial processes or post-consumer products.

The polymeric materials are often introduced into the metallurgical furnaces in the form of a physical mixture containing, in addition to the polymeric material, varying amounts of traditional carbon sources or other materials generally used in metallurgical processes, such as slagging agents (lime, dolomite, etc.). The mixture is generally a mixture of powders, granules, pellets or subdivided units of a larger size.

It is also known to introduce polymeric materials into metallurgical furnaces in the form of composite material, i.e., in the form of agglomerates formed from a matrix consisting of the polymeric material in which at least a second material is dispersed.

For example, U.S. Pat. No. 5,554,207A describes the combined use of a water-insoluble thermoplastic polymer with fine metal particulate in a steel production process in an oxygen converter or EAF. The thermoplastic polymer is preferably a polymer from post-consumer waste recovery, while the metal particulate is obtained by filtering the combustion fumes from the melting furnace. The two materials are combined together under heat, e.g., in an extruder, to form an agglomerated product in which the thermoplastic polymer acts as a binder for the metal particles. The agglomerated product, which is added to the charge of used ferrous scrap, is then used as a vehicle to recover the metal values in the melting furnace and to utilize the thermoplastic material as fuel.

WO 2012/019216 describes the use of a composite product comprising a thermoplastic and a carbon-containing material in high-temperature processes, including EAF furnace processes. As an alternative or in addition to the carbon-containing material, the composite product can contain a metal-containing material. In the examples of WO 2012/019216, the composite material is prepared by extrusion in the form of blocks of relatively high mass, in the order of about 3 kg. The blocks can be used in a steel production process as an auxiliary fuel in addition to the scrap charge. Alternatively, the composite product can be used as a building material or protective material.

Further examples of the use of polymeric materials from the recycling of plastic waste or scrap in metallurgical processes are described in WO2020/230177A1 and WO2020/188615A1.

One of the polymeric materials used in metallurgical processes is the fraction of material remaining at the end of the treatment and sorting processes of plastics from the separate collection of municipal waste (e.g., containers for food, drinks, detergents, etc.). This fraction is also known with the name Plasmix.

The aforementioned plastic treatment and sorting processes are mainly aimed at the recovery of polyethylene (PE), polypropylene (PP) and polyethylene terephthalate (PET), which can be recycled in processes for the production of new plastic products. The residual fraction of unrecovered polymeric material, i.e., Plasmix, consists of a mixture of polymeric materials with, for example, the following percentage composition by weight: 40-50% polyethylene (PE), 20-30% polypropylene (PP), 10-20% polystyrene (PS), 5-10% polyethylene terephthalate (PET) and 2-4% PVC, in addition to varying amounts of contaminants (e.g., paper, metals, glass, pigments, etc.).

However, the use of Plasmix in metallurgy has some drawbacks. First of all, Plasmix is a material with a very heterogeneous chemical composition and little consistency due to the variety of wastes from which it is obtained. Moreover, it is a lightweight material and, before being used, must undergo densification and/or granulation processes to facilitate the transport, storage and dosing thereof in metallurgical furnaces. Furthermore, when Plasmix undergoes heat treatment for densification or granulation, it must be heated to relatively high temperatures due to the different melting temperatures of the polymeric fractions which compose it.

In the prior art, there is therefore a need to find new solutions to limit the environmental impact caused by the use of fossil carbon sources in metallurgical processes.

In view of the aforementioned prior art, the Applicant has set himself the problem of providing a method for producing a ferrous alloy in a metallurgical furnace in which an alternative material to those known in the art is fed to replace, at least partially, the carbon sources of fossil origin.

In particular, an object of the present invention is to provide a method for producing a ferrous alloy in a metallurgical furnace in which said alternative material can be used as a reducing agent, foamy slag-forming agent, fuel, recarburizing agent, deoxydizing agent or to achieve a combination of one or more of these effects.

A further object of the present invention is to provide a method for producing a ferrous alloy in which the aforesaid alternative material can advantageously be used as a vehicle for introducing other materials into a metallurgical furnace, e.g., conventional materials necessary or useful for the metallurgical process.

### SUMMARY OF THE INVENTION

The Applicant has now found that the aforesaid and other objects, which will be better illustrated in the following disclosure, can be achieved by a method for producing a ferrous alloy in a metallurgical furnace in which a granular composite material comprising at least polyethylene and metallic aluminum is fed into the furnace.

Preferably, the aforesaid granular composite material derives from the recovery of post-consumer and/or post-industrial waste materials or waste; in particular, it comprises or consists of the residual fraction of material from the recycling processes of multilayer carton packaging. Multilayer carton packaging is also known as beverage cartons and are marketed, for example, by the companies Tetra Pak® and Elopak®. The aforesaid residual fraction from the recycling processes of multilayer carton packaging is also known as PE-Al. PE-Al is a multilayer material mainly consisting of foils comprising at least one layer of polyethylene and at least one layer of aluminum. PE-Al can further comprise foil layers of other polymeric materials.

Since the polymeric component of the PE-Al composite consists mainly of polyethylene, i.e., an organic polymer based on carbon and hydrogen, and the metal component consists of aluminum, the composite is particularly suitable for use in metallurgical processes to exploit both the chemical reducing action thereof against iron oxides, i.e., by using it as a reducing agent or foamy slag-former, and the calorific power thereof, using it as a fuel. Furthermore, by virtue of the polymeric component, the composite can act as a source of carbon which dissolves in the metal bath, thus exerting a recarburizing action (recarburizing agent).

The use of the PE-Al composite also has the advantage that it does not significantly alter the chemical composition of the molten metal bath and thus of the alloy. In fact, metallic aluminum, after having performed its reducing action against iron oxides or its deoxydizing action against the gaseous oxygen present in the molten metal bath, migrates to the bath surface where it is incorporated into the floating slag layer. Metallic aluminum also gives rise to exothermic chemical reactions during the melting process, which can contribute to improving the energy balance of the metallurgical process.

Since the PE-Al composite is derived from the treatment process of multilayer carton packaging, it can contain cellulose fiber residues. Such residues can act as further reducing agents of biogenic origin, again without changing the chemical composition of the molten metal bath.

A further advantage of the PE-Al composite is that its polymeric component consists almost exclusively of polyethylene, other types of polymers being present in smaller quantities. The chemical composition of the composite is thus homogeneous. Furthermore, the chemical composition of the PE-Al composite is little subject to change due to the essentially uniform composition of the multilayer carton packaging from which it is derived. The polymeric component of the composite also has a relatively low melting point, which facilitates its processability when it is used to prepare densified or extruded materials, possibly containing further components (e.g., biochar, quicklime, dolomite, etc.).

Furthermore, in view of the enormous amount of multilayer carton packaging waste produced worldwide each year, PE-Al composite is a readily available material. Currently, in the prior art it is mainly intended for landfill, energy recovery by incineration and for the manufacture of composite products as a partial replacement for virgin LDPE and HDPE. It is also known to treat PE-Al to recover aluminum by pyrolysis (with simultaneous energy recovery of polyethylene) or to subject it to selective solvent separation processes to recycle the aluminum and polyethylene separately. Therefore, the use of PE-Al in ferrous alloy production processes represents a valuable and innovative opportunity to recycle this waste material.

Therefore, according to a first aspect, the present invention relates to a method for producing a ferrous alloy comprising the following steps:
a. melting a ferrous metal charge in a metallurgical furnace to obtain a mass of molten metal;
b. feeding into said metallurgical furnace, before, during and/or after step a, at least one granular composite material comprising:
   (i) 50%-97% by weight of a polymeric component comprising polyethylene;
   (ii) 3%-50% by weight of metallic aluminum;
the aforesaid percentages by weight referring to the total weight of the polymeric component (i) and the metallic aluminum (ii).

In accordance with a second aspect, the present invention relates to the use of a granular composite material comprising:
(i) 50%-97% by weight of a polymeric component comprising polyethylene,
(ii) 3%-50% by weight of metallic aluminum, the aforesaid weight percentages referring to the total weight of the polymeric component (i) and of the metallic aluminum (ii), in a ferrous alloy production process in a metallurgical furnace, where the aforesaid composite material performs one or more of the following functions: reducing agent, foaming slag-forming agent, fuel, recarburizing agent, deoxydizing agent, or to carry out a combination of said functions.

Further features of the present invention are the subject matter of dependent claims 2 to 17.

### DETAILED DISCLOSURE OF THE INVENTION

The granular composite material usable for the purposes of the present invention comprises a polymeric component and a metal component. The metal component is preferably in the form of particles dispersed within the polymeric component.

The polymeric component t comprises or consists essentially of polyethylene. Preferably, the is low-density polyethylene (LDPE) polyethylene: or linear low-density polyethylene (LLDPE).

The polymeric component can also comprise other polymers, such as high-density polyethylene (HDPE), polypropylene, polyethylene terephthalate, polyamides, and ethylene vinyl alcohol. Preferably, the polymers other than polyethylene are present in a total amount not exceeding 30% by weight of the polymeric component, more preferably not exceeding 15% by weight, even more preferably not exceeding 10% by weight, even more preferably not exceeding 5% by weight.

In an embodiment, the polymeric component comprises polyethylene in an amount equal to or greater than 70% by weight with respect to the weight of the polymeric component, preferably in an amount equal to or greater than 85% by weight, more preferably in an amount equal to or greater than 90% by weight, even more preferably in an amount equal to or greater than 95% by weight.

Preferably, the polymeric component is present in the granular composite material in an amount equal to or greater than 60% by weight with respect to the total weight of the polymeric component (i) and of the metallic aluminum (ii), more preferably in the range 70%-95% by weight, even more preferably in the range 75%-90% by weight.

The metal component of the granular composite material comprises or consists essentially of metallic aluminum. Preferably, the metallic aluminum is in particles form.

The metallic aluminum is present in the granular composite material in an amount equal to or less than 40% by weight with respect to the total weight of the polymeric component (i) and the metallic aluminum (ii). Preferably, the granular composite material comprises metallic aluminum in an amount in the range 5%-30% by weight with respect to the total weight of the polymeric component (i) and the metallic aluminum (ii), more preferably in the range 10%-25% by weight.

The granular composite material can also comprise cellulose fibers, which can derive for example from the incomplete separation of the cellulose component from plastic and aluminum during the recycling process of multilayer carton packaging. Generally, the cellulose fibers are present in the granular composite material in an amount not exceeding 20% by weight with respect to the total weight of the polymeric component and the metallic aluminum, more preferably in an amount not exceeding 10%, even more preferably in an amount in the range 0.5%-5% by weight. In an embodiment, the cellulose fibers are present in the granular composite material in an amount less than 2% by weight with respect to the weight of the composite material, more preferably in an amount less than 1% by weight.

The granular composite material can also comprise water. Preferably, the granular composite material comprises water in an amount equal to or less than 5% by weight with respect to the total weight of the polymeric component (i) and the metallic aluminum (ii), more preferably in an amount in the range 0.5%-5% by weight.

Preferably, the total weight of the polymeric component (i) and the metallic aluminum (ii) in the granular composite material is equal to or greater than 10% by weight with respect to the weight of the composite material, more preferably in the range 25%-100% by weight, even more preferably in the range 60%-100% by weight.

For the purposes of the present invention, the granular composite material described herein is used in the form of subdivided units (granules) of varying size, shape and weight according to the specific requirements of the metallurgical process in which it is used.

The term “granular” means that the components of the composite material are aggregated together to form subdivided units (granules). The granules can greatly vary in shape and size. The granules can be for example in the form of flakes, pellets, compacts, cylinders, spheres or aggregates of other shapes, even irregular ones. Preferably, the granules have a maximum size at most equal to 20 mm, more preferably equal to a maximum of 10 mm, even more preferably equal to a maximum of 5 mm. For the purposes of the present invention, this means that the granules can pass through a square-meshed sieve with sides of 20 mm, preferably 10 mm, more preferably 5 mm, respectively.

For the purposes of the present invention, the term “a maximum dimension” means a characteristic dimension of the granule, such as diameter, length, width or thickness, the extension of which is maximum with respect to the other dimensions.

Preferably, the granules have a bulk density in the range 250 kg/m3-900 kg/m3, more preferably in the range 300 kg/m3-800 kg/m3.

Although the possibility of the granular composite material being obtained, at least in part, from virgin material is not excluded, as mentioned, it is preferably obtained from a recycling treatment of waste materials or scraps. Preferably, the material is obtained from waste deriving from polylaminate packaging having a polymeric fraction and at least one aluminum film. More preferably, the granular composite material comprises or is substantially formed from the fraction of material remaining at the end of a separation process (recycling) of cellulose fibers from multilayer carton packaging. Such a fraction can be used as such to form the granular material. However, since the aforesaid fraction (sometimes also referred to as “PolyAl”) can often still contain significant amounts of undesirable residual materials depending on the effectiveness of the recycling process, it can advantageously be subjected to further preliminary treatments to remove the aforesaid undesired residual materials (e.g., metal components, cellulose, etc.) or to reduce the water content.

In an embodiment, the granular composite material comprises at least one multilayer material comprising polyethylene and metallic aluminum (hereinafter also referred to as “PE-Al composite material”). Preferably, the aforesaid multilayer material is present in the granular composite material in such an amount that at least 50% by weight of the total weight of the metallic aluminum of the granular composite material is provided by said multilayer material, more preferably at least 60% by weight, even more preferably at least 70% by weight, even more preferably from 50% to 100% by weight.

The recycling processes which produce a composite material of the type usable for the purposes of the present invention are known to the person skilled in the art. Recycling processes of multilayer carton packaging from which a PE-Al composite material usable in accordance with the present invention is obtained are described, for example, in EP 0570757 A1 and WO 2009/141796 A1.

As is known, multilayer carton packaging, in particular that for containing liquid foodstuffs (e.g., milk, fruit juices, water, wine, etc.), comprises a carton substrate of cellulose fiber onto which one or more polymeric films are laminated and, in the case of aseptic packaging, at least one aluminum sheet which acts as an impermeable barrier to light and gases. The polymeric films are generally low-density polyethylene (LDPE) and poly (ethylene-co-methacrylic acid) films, the latter having the function of adhering LDPE films to the aluminum sheet. The packaging further contains closure elements (e.g., caps and dispensers) generally made of high-density polyethylene (HDPE).

The packaging from for example the separate collection of municipal waste is subjected to recycling processes to recover mainly the cellulose fiber, which accounts for approximately 70%-75% of the packaging weight. The remaining part of the packaging consists of about 20%-25% by weight of polyethylene and 3%-5% by weight of aluminum.

In accordance with the process described in EP 0570757 A1, for example, the recovery of cellulose fibers can be conducted by water treatment of the carton packaging with pulping mills, e.g., of the type used in the paper industry (hydrapulper). This treatment in water gives rise to an aqueous dispersion (slurry) containing the cellulose fibers and a solid residue comprising a fraction of free polymeric material, a fraction of composite material comprising polymeric material and aluminum, and a fraction of contaminants (e. g., glass, sand, residual cellulose fibers, metals, etc.), the solid residue being suspended in the aqueous dispersion.

Once separated from the dispersion, the cellulose fibers are used again in paper and cardboard production cycles. The free polymeric material fraction (i.e., not forming a composite with aluminum), once separated from the solid residue, is obtained in an essentially pure form and thus suitable for being recycled in production processes of new plastic products, including polymeric films for making new multilayer carton packaging.

The remaining solid residue is subjected to further treatments, e.g., water washing and sedimentation, to separate the residual contaminants and recover a final fraction of composite material. The composite material, which basically consists of a mixture of polymeric material (mainly LDPE and HDPE) and metallic aluminum, is generally obtained in the form of thin lamellar fragments, for example of size 10-30 mm×10-30 mm (PE-Al composite material).

To facilitate the handling and use thereof in metallurgical processes, the PE-Al composite material can advantageously be subjected to densification, extrusion or other suitable processes to obtain a material in a form suitable for feeding into a metallurgical furnace (e.g., lumps, briquettes, pellets, granules, powders, etc.).

The densification and extrusion can be conducted according to techniques and with devices known to the person skilled in the art, e.g., using a densifier or extruder of a type known to the person skilled in the art.

In the present disclosure, the term “densification” refers to the process of treating the PE-Al composite material, alone or in combination with other materials, by which a conglomerate material is obtained having a higher bulk density with respect to that of the starting composite material and/or the possible additional material. The densification can be performed by mechanically compacting the material, possibly by heating it (e.g., to 120° C.-250° C.), to allow the at least partial melting of the plastics and their subsequent agglomeration to form a conglomerate. The conglomerate material can be reduced in size, generally resulting in irregularly shaped granules.

Typically, in a densifier, the material to be densified is subjected to crushing and stirring by means of rotating blades; the agglomeration of the material occurs due to the heat developed by the mechanical friction, possibly accompanied by heat supplied from outside, which causes the partial melting of the thermoplastic component.

Compared to the granules which can be obtained by means of extrusion, the conglomerate granules obtained by densification have a less homogeneous chemical composition and more irregular shape. Extrusion, on the other hand, allows the preparation of granules having a more homogeneous size (more uniform particle size curve) and, in particular in the presence of an intense mixing and dispersion action by an extruder, e.g., a twin-screw extruder, also of granules with a more homogeneous chemical composition in which the aluminum particles are more evenly dispersed in the polymeric matrix.

The granular composite material comprising polyethylene and metallic aluminum can be used in essentially any metallurgical process to produce a ferrous alloy according to the prior art as an at least partial replacement for the normally used carbon sources of fossil origin.

In particular, the method according to the present invention is preferably a method for producing a ferrous alloy such as steel or cast iron.

The method for producing a ferrous alloy according to the present invention comprises a step of melting a metal charge in a metallurgical furnace to obtain a mass of molten metal. The metal charge can comprise any ferrous material of the type generally used in metallurgical processes, such as ferrous scrap or metal ores.

After melting, the molten metal can eventually be refined and then solidified according to techniques known to the person skilled in the art.

In a preferred embodiment, the method according to the present invention is applied to a process carried out in a metallurgical furnace selected from: electric arc furnace, basic oxygen furnace (BOF), converter furnace and blast furnace.

In accordance with an embodiment of the present invention, the granular composite material comprising polyethylene and aluminum can be fed into the furnace prior to starting the melting step of the metal charge, for example by mixing the composite material with the ferrous material loaded in the furnace.

In another embodiment, the granular composite material can be fed into the furnace during the melting step of the metal charge.

In a further embodiment, the granular composite material can be fed into the furnace after the metal charge has been melted, e.g., by injecting it into the molten metal mass or into the slag.

The aforesaid methods of feeding granular composite material can also be applied in combination.

Based on the type of metallurgical process, metallurgical furnace, process step and manner in which the granular composite material is fed, the latter can be fed in widely varying shapes and sizes.

For example, in the event of a steel production process in an EAF furnace, the composite material is preferably injected into the furnace in granular form (e.g., granules having a maximum dimension of 3-10 mm) by means of compressed air lances directly into the floating slag layer and/or into the molten metal bath in the vicinity of the floating slag layer. If the composite material is used primarily as a fuel, in an EAF or other type of furnace, it can be prepared in larger (non-granular) pieces, e.g., of size 10 cm×20 cm, and loaded together with the ferrous material to be melted.

In an embodiment, the granular composite material can be fed to the metallurgical furnace in a physical mixture with at least a second material necessary or useful for the ferrous alloy production process. For example, the granular composite material can be fed in a mixture with an additional material (secondary material) selected from: slagging agent (e.g., calcic, dolomitic, or magnesian quicklime; calcium and/or magnesium carbonate); recycled polymeric material, such as rubber from tire recycling or recycled plastic from plastic packaging waste collection (e.g., PET, PP, PS, ABS, Plasmix, and the like); carbon source of fossil or biogenic origin (e.g., anthracite, coke, char, graphite, woody biomass, etc.); cellulose-based material (e.g., the residual cellulose fraction from recovered beverage cartons), metals, metal oxides, ferro-alloys, carbonates, and a combination of the aforesaid secondary materials.

In these mixtures, the granular composite material can be present in an amount in the range 10% to 90% by weight with respect to the weight of the mixture, the complement to 100% by weight being formed by the secondary material.

In another embodiment, the secondary material to be introduced into the metallurgical furnace and the granular composite material can be advantageously aggregated together to form a filled granular composite material. This embodiment is particularly advantageous when the secondary material is available in a finely divided form, such as powder, and is a material which does not melt when heated to the softening or melting temperature of the polymeric component of the granular composite material.

For example, the relatively low melting temperature of the polyolefin polymeric material (e.g., the melting temperature of polyethylene is about 120° C.) present in the granular composite material can be exploited to generate a filled composite material in which the aluminum and secondary material are uniformly dispersed in a polyolefin-based polymeric matrix, mainly polyethylene.

Preferably, the granular composite material comprising polyethylene and aluminum is present in the filled granular composite material in an overall amount in the range 10%-70% by weight with respect to the weight of the filled granular composite material.

The filled granular composite material incorporating secondary materials can be produced using techniques known to the person skilled in the art, for example in an extruder, preferably a twin-screw extruder, in which the composite material and one or more secondary materials are fed, mixed and extruded together. To promote the preparation of the filled granular composite material, additives of the type generally used in the preparation of polymeric composite materials, e.g., plasticizer additives, can be added.

In a preferred embodiment, the filled granular composite material incorporates at least one biogenic carbonaceous material, i.e., a carbon-containing organic material produced by living animal beings or living plant beings. Preferably, the carbonaceous material is an organic material of plant origin. More preferably, the carbonaceous material is a char. Char is a product obtained from the thermochemical conversion of a biomass in oxygen deficiency, e.g., by pyrolysis, roasting, steam explosion, gasification or hydrothermal charring processes. These thermochemical conversion treatments of biomass allow obtaining a product with a high carbon content, in particular a high fixed carbon content, and a higher calorific value with respect to untreated biomass. Preferably, the biogenic carbonaceous material is a “biochar”, i.e., a char which has been produced by processes considered environmentally sustainable, e.g., involving the exploitation of biomass processing scrap obtained from properly managed forest resources.

The biogenic carbonaceous material preferably has a carbon content equal to or greater than 50% by weight, preferably equal to or greater than 60% by weight, more preferably equal to or greater than 75% by weight with respect to the weight of the carbonaceous material. Preferably, the carbon content is in the range 50%-95%, more preferably 60%-95%, even more preferably 75%-90% by weight with respect to the weight of the carbonaceous material.

The other elements present in char are mainly hydrogen, oxygen and sulphur.

In accordance with a preferred embodiment, the chemical composition of the char is as follows (weight percentages referring to the char weight, on a dry basis):

| | |
|---|---|
| 75%-90% | carbon, |
| 0.5%-4% | hydrogen, |
| 2%-8% | ash, |
| 5%-15% | oxygen, |
| 0%-3% | sulphur. |

An advantageous feature of the char is its relatively low ash content with respect to compared to coal of fossil origin and coke. In fact, ash can interfere with the oxide reduction mechanism, as it forms liquid or solid interfaces which hinder contact between the reactants. Furthermore, ash can locally change the viscosity of the slag and thus the slag's ability to retain gaseous bubbles therein to form a stable foam.

In a preferred embodiment, the char is obtained by means of a roasting or steam explosion process. Preferably, the roasting process comprises the thermal treatment of the starting organic material in oxygen deficiency at a temperature of 200° C. to 350° C. Since in the roasting and steam-explosion processes, the thermochemical conversion of the organic material is carried out at a relatively low temperature with respect to pyrolysis, such processes have a significantly higher char production yield than pyrolysis or gasification (in roasting, up to 0.5-0.9 kg of char can be produced per kg of dry starting material). The roasting and steam-explosion processes are also easier to implement, as they have a smaller volume of gaseous by-products to handle.

With respect to the char from pyrolysis or gasification, the char from roasting and steam explosion generally has a lower total and fixed carbon content, a higher volatile fraction content, and a lower calorific value.

In a preferred embodiment, the char from roasting and steam explosion has one or more of the following features:
Total carbon (on a dry basis): 50-70%;
Fixed carbon (on a dry basis): 18-65%;
Volatile fraction (on a dry basis): 30-80%;
Calorific value: 18.5-30 MJ/kg.

Due to its features, the char from roasting or steam explosion is a biogenic material which, in the prior art, is substantially not used in the steel industry as it presents considerable safety problems due to its high flammability. When used in the composite material in accordance with the present invention, however, it can be advantageously exploited as a foamy slag-forming agent. The present invention thus allows for an expansion of the types of carbon sources alternative to fossil carbon sources available to the metallurgical field today.

Generally, the biogenic carbonaceous material is in the form of flakes or powders or pellets, for example as a function of the starting biomass and the preparation process (pyrolysis, roasting, etc.). The biogenic carbonaceous material can also be processed, e.g., by means of drying and/or grinding so as to obtain a size and water content suitable for the subsequent agglomeration with the polymer.

Typically, to prepare the granular filled composite material, the biogenic carbonaceous material is used in the form of powders or flakes or pellets with a maximum dimension equal to at most 15 mm, more preferably equal to at most 10 mm, even more preferably equal to at most 5 mm. Preferably, the maximum size of the powders or flakes is in the range 1-10 mm, more preferably in the range 2-5 mm.

When the biogenic carbonaceous material is obtained by means of roasting or steam explosion, it is generally commercially available in pellet form. The pellets can be used as such to prepare the composite material according to the present disclosure. Preferably, the pellets have a maximum size equal to at most 50 mm, more preferably equal to at most 40 mm, even more preferably 10 equal to at most 20 mm. Preferably, the maximum size of the pellets is in the range 1-50 mm, more preferably in the range 1-40 mm, even more preferably in the range 2-20 mm.

The creation of filled composite granules which, in addition to polyethylene and aluminum, also contain a biogenic carbonaceous material allows the latter to be easily injected into the metallurgical furnace, overcoming the known drawbacks associated with the use of the same biogenic carbonaceous material in non-agglomerated form. For example, biochar, which is a viable alternative to fossil carbon sources in steel-making processes in EAF furnaces, is in fact currently used only to a very limited extent, as due to its fineness and low density it is injectable in furnaces inefficiently, generates high amounts of diffuse emissions in the working environment as a result of its handling, and causes clogging of the pneumatic conveying systems.

A process for preparing a composite material comprising a polymeric material from recycled waste and a biogenic carbonaceous material, which can be used for the purposes of the present invention, is described in patent application PCT/IB2022/056111.

In another embodiment, the secondary material to be introduced into the metallurgical furnace and the granular composite material can be advantageously aggregated together by densification to form a conglomerate material.

For this purpose, the granular composite material containing polyethylene and aluminum is mixed with the material and the resulting mixture is secondary densified to form the conglomerate material, for example where the secondary material comprises thermoplastic polymeric materials. The conglomerate material can also be dimensionally reduced to form subdivided units of a shape and size suitable for feeding into a metallurgical furnace (granules).

Preferably, the granular composite material comprising polyethylene and aluminum is present in the conglomerate material in the range 10%-90% by weight with respect to the weight of the conglomerate material, the complement to 100% by weight being formed by the secondary material.

Densification can advantageously be used to introduce the composite material into a metallurgical furnace together with additional materials (secondary materials), such as recycled polymeric material (e.g., rubber from recycled tires and recycled plastic or Plasmix). By means of densification, it is possible to prepare a conglomerate material in which the granular composite material comprising polyethylene and aluminum is present in a weight ratio with respect to the secondary material which varies over a wide range of values. For example, the weight ratio between the granular composite material and the secondary material can be in the range 1:10 to 10:1.

By using the granular composite material comprising polyethylene and aluminum in conglomerate form with an additional material consisting of Plasmix, undesirable species such as chlorine, nitrogen and ash generated by the Plasmix can, for example, be reduced by dilution, thanks to the contribution of the polyolefin fraction of the granular composite material.

The composite material in conglomerate form, especially when conglomerated with Plasmix or another polymeric material, can also be filled with a further (non-thermoplastic) solid secondary material to make a filled granular composite material. The conglomeration of the plastics and the filling of the further secondary material can be performed simultaneously, e.g., in an extruder.

The feeding of the granular composite material to the metallurgical furnace can be carried out according to techniques and with the devices known to the person skilled in the art.

For example, the granular composite material can be introduced into a metallurgical furnace by means of injection with one or more lances. The lances typically extend inside the furnace through openings in the side walls or on the roof of the furnace. The lances generally employ a gaseous current (e.g., compressed air) to convey the granules.

When the granular composite material is used as a slag-forming agent, e.g., in an EAF furnace for steel production, it is preferably dispersed in the floating slag layer and/or in the molten metal bath in the vicinity of the floating slag layer. Generally, this operation is performed when the melting of the metal charge is at an advanced stage and/or when it is finished.

Once injected into the furnace, the composite material comes into contact with the slag, triggering multiple chemical reactions which lead to the foaming of the slag and simultaneously to the reduction of the iron oxide to liquid metallic iron. The reaction of the composite material in the slag occurs in two stages: in a first stage, the polymeric fraction of the composite material leads to a cracking process with the formation of mainly hydrocarbons, solid carbon, carbon monoxide and hydrogen, which partly reduce the iron oxide; in a second stage, the aluminum oxidation occurs.

Without wishing to refer to any particular theory, it is believed that, following the introduction of the granules into the furnace, the composite material is converted very rapidly, giving rise mainly to the following reactions:

$$polimero \to {C}_{n} {H}_{{m}_{( g )}} \qquad ( 1 )$$

$${C}_{n} {H}_{{m}_{( g )}} = {n C}_{( s )} + \frac{m}{2} {H}_{{2}_{( g )}} \qquad ( 2 )$$

$${C}_{n} {H}_{{m}_{( g )}} + n {CO}_{{2}_{( g )}} = 2 n {CO}_{( g )} + \frac{m}{2} {H}_{{2}_{( g )}} \qquad ( 3 )$$

$$\overline{FeO} + {H}_{{2}_{( g )}} = {Fe}_{( l )} + {H}_{2} {O}_{( g )} \qquad ( 4 )$$

$$\overline{FeO} + \frac{1}{n} {C}_{n} {H}_{m} = {Fe}_{( l )} + {CO}_{( g )} + \frac{m}{2 n} {H}_{{2}_{( g )}} \qquad ( 5 )$$

$${C}_{( s )} + {H}_{2} {O}_{( g )} = {H}_{{2}_{( g )}} + {CO}_{( g )} \qquad ( 6 )$$

$$\overline{FeO} + {C}_{( s )} = {Fe}_{( l )} + {CO}_{( g )} \qquad ( 7 )$$

$$\overline{FeO} + {CO}_{( g )} = {Fe}_{( l )} + {CO}_{{2}_{( g )}} \qquad ( 8 )$$

$${C}_{( s )} + {CO}_{{2}_{( g )}} = 2 {CO}_{( g )} \qquad ( 9 )$$

First, the polymeric chains of the polymeric material break to form hydrocarbons and shorter hydrocarbon chains (reaction 1). In turn, these decompose to give carbon in solid form and hydrogen gas according to reaction 2. They can also react with the carbon dioxide (reaction 3) or with the iron oxide from the slag (reaction 5) to form carbon monoxide, hydrogen and, by the reaction with the slag, metallic iron.

Reactions 2, 3 and 5 have hydrogen as reaction product, which in turn acts as reducing agent. Based on reaction 4, the hydrogen is capable of reducing the iron oxide with faster reaction kinetics with respect to the carbon monoxide. This also favors the formation of numerous small gaseous bubbles with a consequent stabilizing effect on the foamy slag, as this thereby facilitates the retention of the gaseous phase inside the slag. Reaction 4 also produces water, which, similarly to carbon dioxide, is capable of gasifying the solid carbon according to reaction 6 with the formation of hydrogen and carbon monoxide. The solid carbon and carbon monoxide can then reduce the iron oxide according to reaction 7 and 8. The formation of carbon dioxide will then favor the conversion of solid carbon to carbon monoxide according to reaction 9.

The aluminum fraction of the granular composite material, given this metal's high affinity for oxygen, will also behave as a reducing agent, giving rise to reactions 10 such as:

$$3 \overline{FeO} + 2 {Al}_{( l )} = 3 {Fe}_{( l )} + \overline{A {l}_{2} {O}_{3}} \qquad ( 10 )$$

The aluminum will then either become part of the slag in the form of an oxide (with the concomitant development of heat through the exothermic reaction 10) or can remain in the bath as an alloying element if it is not oxidized. Thereby, both the polymeric component and the aluminum of the granular composite material act as reducing agents of the iron oxides to give metallic iron, while the aluminum also becomes part of the slag. The slag has physical and mechanical features comparable to those of inert aggregates of natural origin (e.g., sands, gravels and basalts) and can therefore be used in civil engineering and construction works.

The operating steps of the ferrous alloy production process which precede and follow the foaming step of the floating slag are conventional operations, performed in accordance with the prior art.

Initially, for example, the metal charge to be melted can be introduced into the furnace by one or more charging operations, possibly interspersed with intermediate melting steps. Alternatively, the metal charge can be fed into the furnace continuously after preheating, as is known in the art.

Once the chemical composition of the molten metal bath and its temperature have been optimized, the molten metal of ferrous alloy is tapped from the furnace, separating it from the slag. The ferrous alloy thus obtained is then sent for further processing to transform it into the final finished product.

The following examples are provided purely for the purpose of illustration of the present invention and should not be regarded as limiting the scope of protection defined by the appended claims.

In the examples, reference will also be made to the attached figures in which:

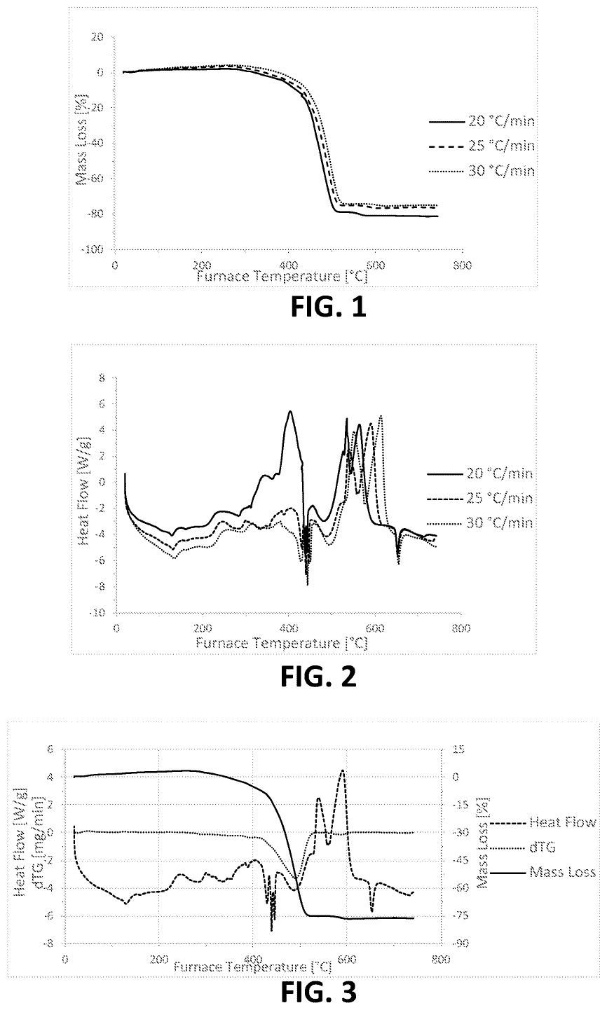

FIGS. 1-3 show the results of the thermogravimetric analysis of a granular composite material according to the invention obtained by granulating PE-Al (Example 1);

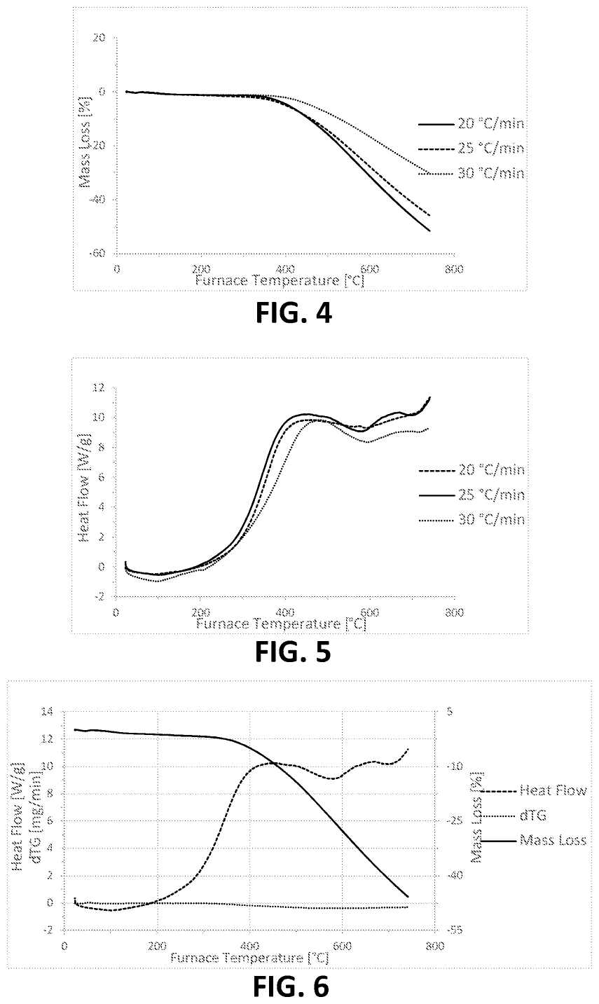

FIGS. 4-6 show the results of the thermogravimetric analysis of a biochar produced by means of pyrolysis;

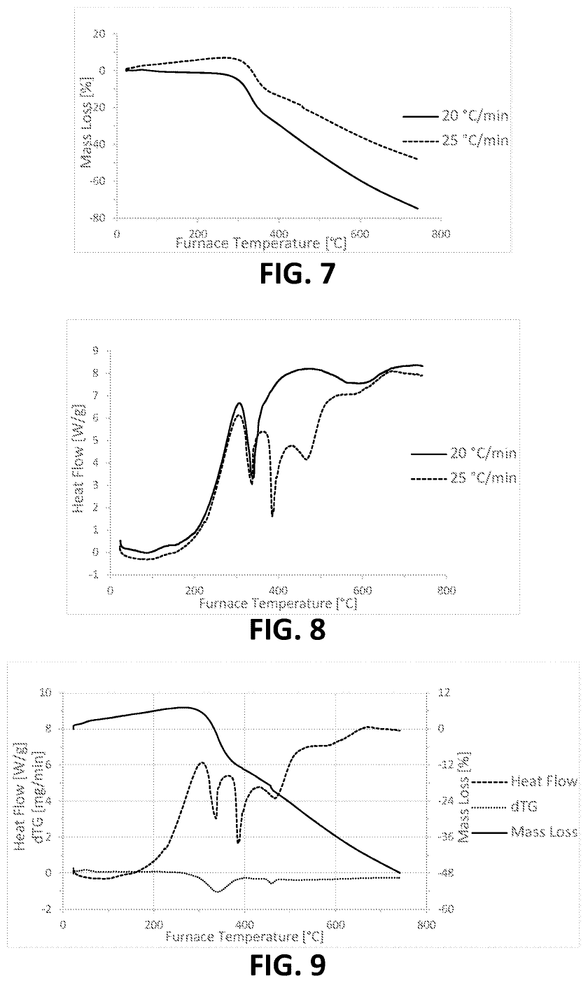

FIGS. 7-9 show the results of the thermogravimetric analysis of a biochar produced by means of roasting;

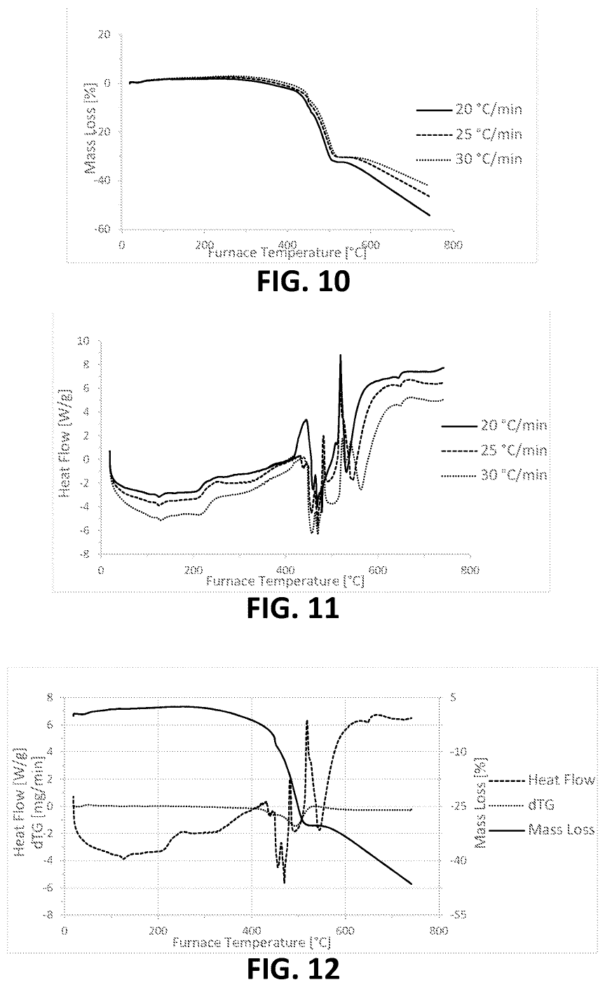

FIGS. 10-12 show the results of the thermogravimetric analysis of a granular composite material filled with biochar produced by means of pyrolysis (Example 3-Sample 1);

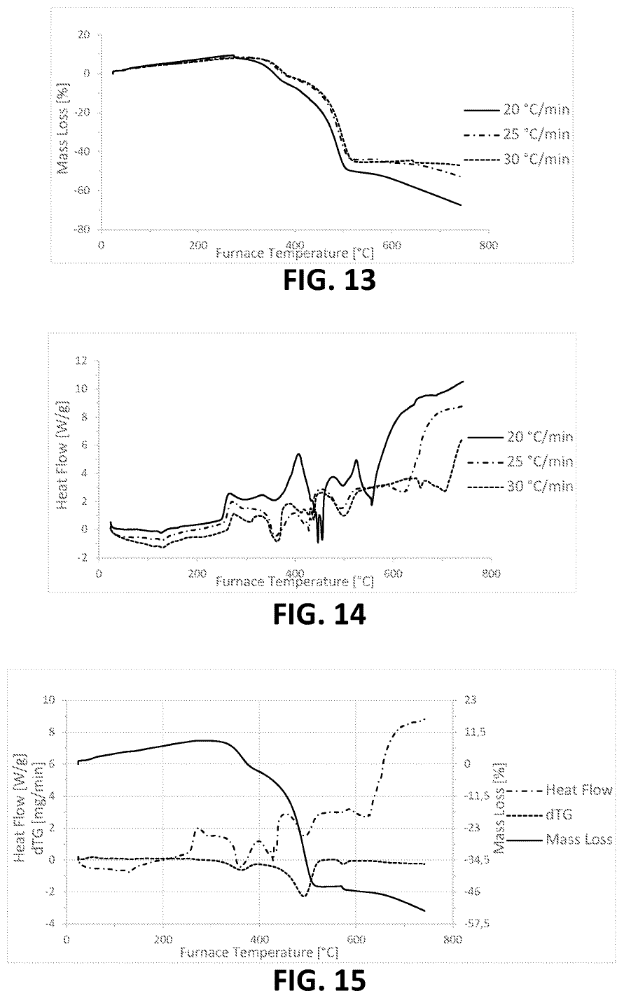

FIGS. 13-15 show the results of the thermogravimetric analysis of a granular composite material filled with biochar produced by means of roasting (Example 3-Sample 2);

FIG. 16 shows a comparison of the results of the thermogravimetric (TG) analysis of the biochar from pyrolysis of FIG. 4 and the filled granular composite material (Example 3-Sample 1) of FIG. 10;

FIG. 17 shows a comparison of the results of the thermogravimetric (HF) analysis of the biochar from pyrolysis of FIG. 5 and the filled granular composite material (Example 3-Sample 1) of FIG. 11;

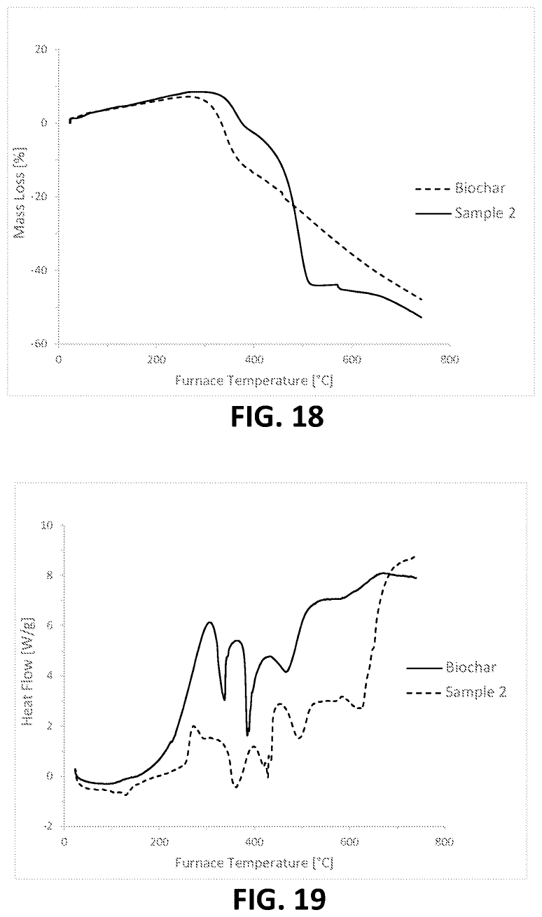

FIG. 18 shows a comparison of the results of the thermogravimetric (TG) analysis of the biochar from roasting of FIG. 7 and the filled granular composite material (Example 3-Sample 2) of FIG. 13;

FIG. 19 shows a comparison of the results of the thermogravimetric (HF) analysis of the biochar from roasting of FIG. 8 and the filled granular composite material (Example 3-Sample 2) of FIG. 14.

### EXAMPLES

### Example 1 (Granules of PE-Al Composite Material)

A recycled composite material comprising polyethylene, residues of other plastics, aluminum and residual cellulose fibers, obtained from a recycling process of multilayer carton packaging in a hydraulic pulper, was treated to remove foreign bodies, residual cellulose and water in the following manner:
Washing the composite material in a water bath and separation by sedimentation of the heavy foreign bodies and the suspended solid fraction comprising the composite material;
centrifugation of the solid fraction comprising the composite material to reduce the water content thereof;
grinding and drying of the centrifuged solid fraction to obtain a dried composite material in the form of foils, with a water content less than 2% and a cellulose content less than 2%
densification of the dried composite material in a rotary-blade densifier with the formation of irregularly shaped and sized granules;
extrusion of the densified granules to obtain a material in granular form, with granules of homogeneous composition, shape and size.

The resulting composite material consists of granules with an aluminum content equal to about 15% and a polymer content, mainly polyethylene, equal to about 85%, the aforesaid percentages being percentages by weight referring to the weight of the composite material. The granules, which contain metallic aluminum in the form of dispersed particles, have, for example, a maximum dimension equal to about 5 mm and an apparent density of about 570 kg/m3.

The granules are then in a suitable format to be fed to a metallurgical furnace in a ferrous alloy production process. For example, the granules can be injected, by means of a lance, into the slag floating on a molten metal bath inside an electric arc furnace to promote slag foaming.

The granules were thermally analyzed to characterize the behavior thereof. The analyzed material samples were heated with different heating rates (20, 25, 30° C./min) from room temperature up to 750° C.) in fluxed air. During the tests, the mass loss (TG), mass change rate (dTG) and heat flux (HF) were measured.

FIG. 1 shows the mass loss for the analyzed granules. The loss is concentrated in the temperature range between 40° and 500° C. Up to a temperature of 400° C., the mass reduction is less than 9% by weight. From 400 to 450° C., the degradation of the polymer accelerates, reaching a mass loss of −22%, −18% and −13% for a heating rate of 20, 25 and 30° C./min, respectively. At 500° C., the TG values for the three cases are: −75%, −64% and −55% by weight. At the maximum temperature of 750° C., the residual mass is 19%, 24% and 25% by weight of the original sample.

The heat flow displayed in FIG. 2 shows a strong endothermicity due to the melting and degradation of the polymeric component. Only for the sample tested at 20° C./min does a heat release occur in the 400° C. range. Exothermic reactions are then present for each curve in the 550-600° C. range, probably due to the combustion of gaseous species or carbonaceous material. The localized endothermic peak at 650° C. is related to the melting of the metallic aluminum and shows that some of the aluminum is not oxidized during the test. Therefore, the residual fraction is mainly a mixture of metallic aluminum and alumina. The latter results in an increase in the weight of the sample, as due to the oxidation of the aluminum to alumina, the mass increases by a factor of 1.88. The graph in FIG. 3 more clearly shows how the mass loss is mainly concentrated only in a narrow temperature range (curve dTG) with the maximum decomposition rate localized at around 490° C. The three samples showed very similar behavior in terms of TG and HF. Only for the sample tested at 20° C./min are there slight differences, reasonably related to a lower aluminum content.

The PE-Al composite granules also comply with the requirements of EN10667-17, which prescribes the requirements for plastic residues for use as reducing and/or foaming agents in metallurgical and steel processes. In particular, the granules meet the requirements set for: minimum content of mixed plastics, low heating value, maximum content of contaminants (e.g., Cl, Cd, Pb and Hg).

The analysis shows that the polymeric component protects the metallic aluminum from premature oxidation, which is then effectively introduced into the metallurgical furnace where it can exert its reducing action. In particular, when using granules as a foaming agent in electric arc furnaces, the presence of aluminum is advantageous because:
it increases iron recovery because its affinity for oxygen is greater than that of iron. The aluminum will then act as a strong reducing agent following the overall reaction:

$$FeO + \frac{2}{3} A l \to F e + \frac{1}{3} A {l}_{2} {O}_{3}$$

according to which for every kg of Al injected into slag, 3.1 kg of Fe is recovered;
the above equation is exothermic since it implies a net enthalpy development of −260 KJ/molFe (14 MJ/kgAl);
the localized temperature increase due to such exothermicity favors the formation of CO by means of the reaction:

$$C + O \to CO$$

resulting in a stabilization of the foamy slag;
the increase in the concentration of Al₂O₃ stabilizes the slag, as the alumina is present in a lower concentration than that of the FeO (three oxygen atoms are needed to obtain one Al₂O₃ molecule), thus improving the basicity index BI₅. Al₂O₃ is also less acidic than SiO₂ in terms of furnace refractory consumption;

$$B {I}_{5} = \frac{\% CaO + \% MgO}{\% {SiO}_{2} + \% {Al}_{2} {O}_{3} + \% FeO}$$

Al₂O₃ improves the slag vitrification process, reducing the risk of leaching and thus the release of hazardous chemical species into the environment. This promotes the recycling of the electric arc furnace slag for use as construction material.

The PE-Al composite granules can therefore be used as a foamy slag-forming agent in an electric arc furnace with satisfactory results.

### Example 2 (Physical Mixture of Composite Material, Coal and Dolomite and Additional Materials)

100 kg of composite granules from Example 1 were mixed with coal (anthracite) and dolomite in the following proportions:
100 kg composite material
300 kg anthracite
250 kg dolomite (calcium magnesium carbonate).

The mixture is suitable to be fed into a metallurgical furnace, e.g., an EAF, as a partial replacement for hard coal.

### Example 3 (Granular Composite Material Filled with Biogenic Carbonaceous Material)

Two samples of filled composite material were prepared in the following manner.

Sample 1: 45% PE-Al composite, 55% biochar from pyrolysis (mass percentages referring to the sum of the masses of PE-Al and biochar)

45 kg of densified (non-extruded) composite material from Example 1 was fed to a twin-screw extruder together with 55 kg of powdered biochar obtained by means of high-temperature pyrolysis (particles having size 0.1-5 mm), the latter being fed by means of three side injectors. In the plastic fluid phase, obtained by melting the polymeric component of the material, the metallic aluminum and biochar particles are homogeneously dispersed in the polyethylene matrix. The filled composite material was then extruded in the form of granules with a maximum size of about 5.5 mm and an apparent density of 600 kg/m3.

The biochar used had the following composition:
Fixed carbon content on a dry basis: 90%
Ash content on a dry basis: 3%
Water content: 2%
Calorific value: 34 MJ/kg

Sample 2: 50% PE-Al composite, 50% biochar from roasting (mass percentages referring to the sum of the masses of PE-Al and biochar)

A material consisting of 50% mass of densified (non-extruded) composite material in granules from Example 1 was fed to a twin-screw extruder together with 50% mass of powdered biochar obtained by means of roasting (particles having size <2 mm), the latter being fed by means of three side injectors. In the plastic fluid phase, obtained by melting the polymeric component of the material, the metallic aluminum and biochar particles are homogeneously dispersed in the polyethylene matrix. The filled composite material was then extruded in the form of granules of maximum size of about 7 mm and has an apparent density of 400 kg/m3.

The biochar from roasting had the following composition (% w/w):
Fixed carbon content on a dry basis: 35-45%
Ash content on a dry basis: <4%
Water content: <3%
Calorific value: 22.5 MJ/kg

The two types of biochar and the two samples were characterized by means of thermal analysis, subjecting them to different heating rates (20, 25, 30° C./min) in fluxed air.

FIGS. 4 and 5 show the mass loss and heat flow for the biochar from high-temperature pyrolysis. The mass loss curves show the same trend for the three heating rates, with a shift to the right as the heating rate increases. The material shows slow oxidation, with a gradual increase in heat flux until a more stable condition is reached, around 10 W/g. Once the maximum temperature has been reached, the combustion of the material is not yet complete. Such behavior is in line with the high content of fixed carbon which characterizes this type of biochar. FIG. 6 shows that there are no significant peaks in terms of mass loss (dTG), confirming that this type of biochar behaves as a homogeneous, carbon-rich material.

The behavior of the biochar from roasting, analyzed for only two heating rates (20° C./min and 25° C./min), shows differences. As with the biochar from high-temperature pyrolysis, the material is subject to combustion, but the TG curves show a different mass loss with final values of −48% for the sample tested at 25° C./min and −75% for the sample tested at 20° C./min (FIG. 7). The heat flow curves (FIG. 8) then show a complex trend between 300° C. and 500° C. This appears to be attributable to a less homogeneous chemical composition of the roasted material with respect to the biochar from high-temperature pyrolysis. FIG. 9 then shows the presence of two mass loss peaks, a first, more pronounced one around 350° C., probably connected to the volatilization of the cellulose, and then another one around 450° C. probably due to the products deriving from the lignin rearrangement. As with the biochar from high-temperature pyrolysis, the heat flow stabilizes at higher temperatures, in this case around 8 W/g, and, again similar to what occurs for the previous type of biochar, when the maximum temperature is reached, the oxidation of the material is not yet complete.

The behavior of Sample 1 is basically a combination of the curves of the biochar from high-temperature pyrolysis and the PE-Al composite granule. FIG. 10 shows that significant mass loss begins around 400° C., when the polymeric fraction starts to degrade. Then, after 500° C., when the conversion of the polymeric material is almost complete, the curve pattern resembles that of pure biochar, with slow oxidation. The heat flow (FIG. 11) shows that up to around 500° C., the endothermic behavior of the polymers prevails over the combustion of the biochar. The carbonaceous residue then sees a gradual increase in heat release until a more stable condition is reached. While even for Sample 1 the combustion is not complete when the temperature of 750° C. is reached, with respect to pure biochar the final heat flux reaches different levels depending on the heating rate. The lower the heating rate, the higher the value of the final heat flow. Although less obvious with respect to the PE-Al composite granule, it can be seen that once the melting temperature of metallic aluminum is reached, there is a peak in heat absorption. Thus, even for Sample 1, part of the aluminum is not fully oxidized when its melting temperature is reached. The curve dTG in FIG. 12 then confirms the mass loss trend described above, with only one peak at 490° C. (as for the PE-Al composite material granule in example 1) and then a localized acceleration after 550° C.

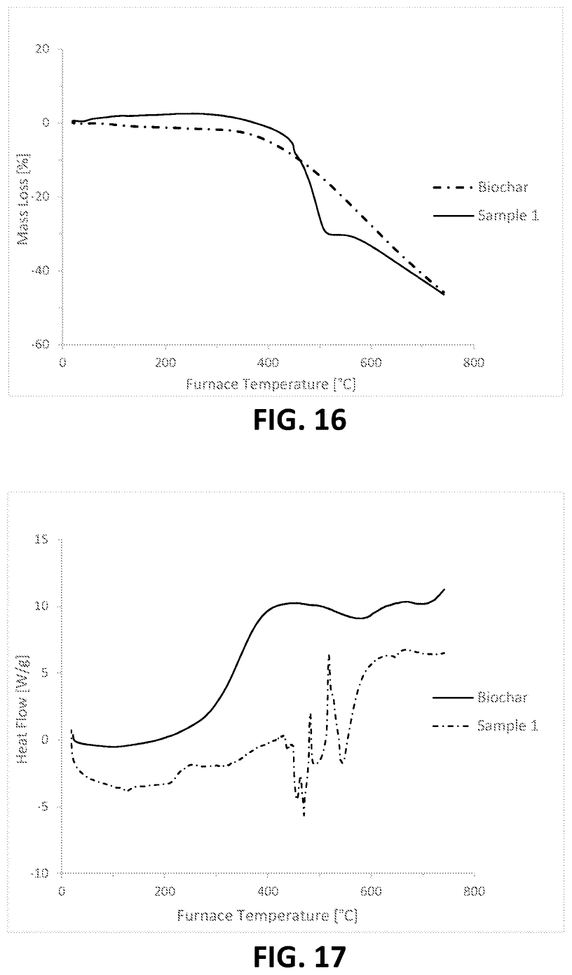

Like Sample 1, Sample 2 also has a behavior resembling the overlapping of the curves of the biochar from roasting and the PE-Al composite granule. However, the mass loss (FIG. 13) and heat flow (FIG. 14) curves are more complex, probably due to the more heterogeneous nature of the roasted material. A first mass loss seems to occur around 350° C. and then a second, more significant one after 400° C. The first is probably related to the cellulose contained in the biochar while the second, as in Sample 1, to the polymeric fraction. This is also confirmed by the curve dTG (FIG. 15) which shows a mass loss rate peak at 360° C. and another at 490° C. Interestingly, as with Sample 1, the heat flux values reached at 750° C. are different for the three heating rates. Again, the higher the heating rate, the lower the heat flow, but the curves do not reach a stable condition. While for the 20° C./min and 25° C./min cases the curves appear to be starting to change slope, for the 30° C./min case the heat flux is still increasing. For the latter heating rate, the melting point of the metallic aluminum is also visible from the HF curve. For the two lower heating rates, that point is either not present (for 20° C./min) or barely perceptible in a localized double slope change (for 25° C./min). This could be attributed to the oxidation of the aluminum by the oxygen originally contained in the biochar.

Further information can be obtained by comparing the mass loss and heat flow for each type of biochar and the corresponding aggregate granule with the PE-Al composite. For both types of analyzed biochar, the presence of the polymeric matrix prevents mass loss at lower temperatures (FIG. 16 and FIG. 17). Subsequently, due to the polymer degradation, the mass loss of the filled material accelerates and the measured residual mass falls below that of the corresponding biochar in pure form. For Sample 1, this point falls around 465° C., while for Sample 2 it is in the range of 480° C. It can be seen that the presence of the polymeric material reduces the heat flow values when comparing the filled materials and the corresponding type of biochar (FIG. 18 and FIG. 19). For Sample 1, there is always a wide range between the curves HF over the entire temperature range analyzed. In the case of Sample 2, such a range is still present, even though after 600° C. the heat flux of the filled material starts to increase significantly until, near 700° C., the value of HF of the filled product exceeds that of the biochar from roasting. The thermal analysis thus suggests that the material filled the PE-Al composite material carries out a protective action on the biochar from a thermo-oxidative point of view. Furthermore, the possibility of controlling particle size allows the control of the surface-to-volume ratio and, consequently, of the heat transfer between each particle and the environment within a metallurgical furnace. The polymeric matrix also limits the release of fine dust fractions which could be lost in the furnace or act as initiators of rapid oxidation processes.

The experimental data show that the biochar-filled composite material is suitable to be fed into a metallurgical furnace, e.g., an EAF. The granules are also an optimal vehicle for injecting biochar into metallurgical furnaces as an at least partial replacement for carbon of fossil origin.

In fact, Sample 1 and Sample 2 were used as a foamy slag-forming agent in an electric arc furnace.

The effectiveness of the filled material granules is evident in the different stages characterizing the use thereof. In particular, the advantages of the material described in the present invention emerge from a comparison with hard coal, and more specifically anthracite, which is the material mainly adopted for slag injection, and from a comparison with two other theoretically alternative solutions: densified mixed plastics and biochar in pure form.

### Transport

The filled material granules have a high bulk density. Looking at Sample 1 (density approx. 600 kg/m3) and Sample 2 (density approx. 400 kg/m3), the density, although lower than that of anthracite (approx. 900 kg/m3), is from 30% to 100% higher with respect to that of mixed post-consumer plastics in densified form (density approx. 300 kg/m3). It is also up to 2-4 times greater than that of biochar in powdered form.

This implies fewer trucks to transport the material up to the steel mill, resulting in lower pollutant emissions and logistics costs. The steel site will then be less congested in terms of handling incoming materials.

### Storage and Handling in Steelworks

Looking at a comparison with alternative materials, such as densified mixed plastics and biochar in pure form, the storage is simplified by being able to use silos with a smaller volume for the same mass contained therein.

The material filled according to the present invention, unlike biochar, does not suffer from hygroscopicity problems, which would complicate storage over long periods of time

From the point of view of safety, the agglomeration of biochar with polymeric material results in mechanically solid particles, thus solving the problem of the presence of abundant fine, flammable and explosive dust which characterizes biochar. For example, the transfer of material from big bags to inside silos for injection into the furnace showed no perceptible release of powdery phases into the environment. This is also an improvement in comparison with normal anthracite practices.

At the same time, the agglomeration solves the problem of the reactivity of biochar with air. Due to such reactivity, the biochar is subject to the risk of self-ignition if stored in large volumes for extended periods of time, and is an easily ignited material. Dispersing and trapping the biochar inside the polymeric matrix thus minimizes any risk at the steel site.

### Pneumatic Transport to the Injection Lances

Thanks to their physical form, the filled material granules prove to be particularly suitable for pneumatic transport from pressurized tanks up to the injection lances in furnaces. Indeed, the material exhibits excellent flowability, far better with respect to densified mixed plastics, allowing a precise flow regulation. Such an aspect translates into the ability to optimally control the injection process with consequent impacts in terms of energy consumption and emissions.

Agglomeration also solves the problem of the propensity of biochar to form powdery fractions of varying particle size. In fact, biochar powder tends to pile up, particularly in bends or taperings, making flow rate control difficult.

### Injection

In view of the lower apparent density with respect to anthracite, similarly to what would occur for densified plastics and biochar in pure form, the granules of biochar-filled material also require an adaptation of the lances. Such modifications can relate to the injection angle, or the adoption of a secondary entrainment flow (e.g., oxygen jet) to allow an effective penetration of the material in slag.

With respect to densified plastics or biochar, biochar-filled granules have a higher density, reducing the problems associated with the material's ability to penetrate in the slag.

Furthermore, the almost total absence of a powdery phase, which characterizes both anthracite and densified plastics, but above all biochar, limits the loss of material due to the entrainment of such fine particles in the gases rising from the bath. Such particles can then be wasted due to their propensity to oxidize or volatilize before reaching slag. Looking at the latter aspect, the extrusion in granules of the material according to the invention allows controlling the surface area/volume ratio of the particles. This impacts both the heat exchange mechanisms to which the granules are subjected during the injection into the furnace, and the reacting surfaces of the particles. By controlling the size, it is therefore possible to optimize the effectiveness of the material with respect to injection: particles which are too fine, in addition to possible difficulties in penetrating the slag, tend to rise rapidly in temperature with a rapid release of the volatile fraction or rapid oxidation; particles which are too large, on the other hand, show a tendency to float on the slag, contributing only partially to the mechanisms of iron oxide reduction and the formation of a foamy slag.

The indication that the benefits expected from a theoretical point of view have materialized in practical application can be seen in the fact that when replacing anthracite with composite granules, no anomalies were encountered in the furnace. In particular, there were no more flames than usual and the temperatures of both the cooled panels and the exhaust fumes remained within the historical range.

The fact that granules produced with biochar from both high-temperature pyrolysis and roasting worked also indicates that the polymer effectively protected the biochar from thermo-oxidation. Thereby, biochar from roasting was also able to reach the slag, releasing its substantial volatile fraction and related reducing potential therein.

### Reactivity Towards Slag

The granules produced are designed to have a uniform dispersion of biochar, polymer and aluminum. This is intended to maximize the interaction between biochar, polymer and aluminum, which are already in perfect physical contact with each other, and the slag. In addition to providing thermo-oxidative protection to the biochar as described for the injection process, the polymer solves the problems of low reactivity with slag associated with biogenic carbonaceous material. The problems with biochar appear to be due to the smooth surfaces at the nanometer and micrometer level, which would favor the formation of stable gaseous stratifications and thus be able to stop the reducing action on the slag. On the other hand, the abundance of hydrogen and the intense mass exchange associated with the polymeric fraction should accelerate the kinetics of the reduction process, particularly in the presence of solid carbon such as that provided by the biochar. Furthermore, the possibility that hydrocarbon species due to the polymeric fraction can interact with the solid carbon, pyrolyzing and forming carbon deposits on the latter's surfaces, can further facilitate the resolution of problems associated with biochar. Aluminum, on the other hand, acts as a strong reducing agent against the slag, either directly (contact between Al and FeO) or indirectly by stripping oxygen from the gaseous intermediates bound to the biochar or polymeric fraction (which, deprived of oxygen, will subsequently reduce the slag). As such mechanisms are exothermic, the heat released locally supports the reduction reactions due to the biochar and polymeric fraction. The presence of aluminum further improves the slag basicity index (BI₅), increasing the propensity of the slag to swell. Furthermore, the alumina in which the slag is enriched favors the vitrification process, thus limiting the leaching process and the subsequent release of undesirable chemical species from the solidified slag.

The fact that composite granules were capable of completely replacing the anthracite in the tests conducted suggests that one or more of the previously described mechanisms did indeed occur.

The composite material also showed a superior effectiveness to anthracite in terms of foam slag quality (excellent arc coverage) and similar to anthracite in terms of injected mass. This suggests that in spite of the different chemical-physical behavior with respect to hard coal, even in the presence of the filled material, gaseous bubbles were formed capable of generating a stable foamy slag.

### Climate-Changing Emissions

Replacing hard coal (anthracite) with the biochar-filled material resulted in a significant reduction in climate-changing emissions.

The anthracite adopted in steel mills is characterized by a high carbon content, of around 92%, corresponding to specific emissions of 3.37 kgCO₂/kg.

Under 1:1 substitution conditions, a direct emission saving of about 60% was thus achieved for Sample 1 and Sample 2.

The emission reductions can then be increased by increasing the fraction of biogenic carbonaceous material or by identifying any biogenic-derived fraction in the polymeric matrix.

In addition to the reduction of direct emissions, the indirect reduction of environmental impact occurs due to the replacement of a fossil material with a composite based on a renewable material (the biogenic carbonaceous fraction) and a circular one (the polymeric fraction derived from waste recycling).

### Example 4 (Conglomerate Material Comprising Composite Material and Recycled Plastic)

An aggregate in the form of a conglomerate material was prepared as follows.

200 kg of densified composite material (not subjected to extrusion) from Example 1 were mixed with 800 kg of mixed post-consumer plastic obtained downstream of the waste sorting of waste from separate collection (Plasmix). The mixture was subjected to extrusion in a twin-screw extruder. The conglomerate material was then extruded in the form of granules with a maximum size of about 5.5 mm

The granules are suitable for use in a metallurgical furnace as a replacement for fossil carbon sources, e.g., as slag-forming agents in an EAF furnace. The granules improve the chemical input to the foaming slag formation process of mixed plastics, thanks to an increase in the polyolefin fraction, and reduce the input of undesirable species contained in Plasmix by dilution, such as chlorine, nitrogen and ash, during the ferrous alloy production process.

The invention claimed is:

1. A method for producing a ferrous alloy, the method comprising:
melting a ferrous metal charge in a metallurgical furnace to obtain a mass of molten metal; and
feeding into the metallurgical furnace, before, during, and/or after the melting of the ferrous metal charge, at least one granular composite material comprising:
greater than or equal to 50% and less than or equal to 97% by weight of a polymeric component comprising polyethylene; and
greater than or equal to 3% and less than or equal to 50% by weight of metallic aluminum;
wherein the percentages by weight refer to a total weight of the polymeric component comprising polyethylene and the metallic aluminum.

2. The method of claim 1, wherein the at least one granular composite material comprises at least one multilayer material comprising the polyethylene and the metallic aluminum.

3. The method of claim 1, wherein the polymeric component comprising polyethylene is present in the at least one granular composite material in an amount greater than or equal to 70% and less than or equal to 95% by weight with respect to the total weight of the polymeric component comprising polyethylene and the metallic aluminum.

4. The method of claim 1, wherein the at least one granular composite material comprises the metallic aluminum in an amount greater than or equal to 5% and less than or equal to 30% by weight with respect to the total weight of the polymeric component comprising polyethylene and the metallic aluminum.

5. The method of claim 1, wherein the polymeric component comprising polyethylene comprises the polyethylene in an amount greater than or equal to 70% by weight with respect to a weight of the polymeric component comprising polyethylene.

6. The method of claim 1, wherein the at least one granular composite material comprises cellulose fibers in an amount greater than or equal to 0.5% and less than or equal to 20% by weight with respect to the total weight of the polymeric component comprising polyethylene and the metallic aluminum.

7. The method of claim 1, wherein the at least one granular composite material comprises water in an amount less than or equal to 5% by weight with respect to the total weight of the polymeric component comprising polyethylene and the metallic aluminum.

8. The method of claim 1, wherein the at least one granular composite material comprises at least one carbonaceous material.

9. The method of claim 1, wherein the at least one granular composite material is fed into the metallurgical furnace in a form of a physical mixture with one or more of the following materials: slagging agent, recycled polymeric material, carbon source, and cellulose-based material.

10. The method of claim 1, wherein the at least one granular composite material is fed into the metallurgical furnace in aggregate form with one or more of the following materials: slagging agent, recycled polymeric material, carbon source, cellulose-based material, metal, metal oxide, ferro-alloy, and carbonate.

11. The method of claim 1, wherein the at least one granular composite material comprises at least one carbon source of fossil or biogenic origin.

12. The method of claim 1, wherein the at least one granular composite material comprises at least one carbon source of fossil or biogenic origin selected from char, biochar, or char and biochar, and
wherein the char, biochar, or char and biochar is obtained using a process selected from: gasification, pyrolysis, roasting, hydrothermal charring, or steam explosion.

13. The method of claim 1, wherein the at least one granular composite material is fed into the metallurgical furnace in a form of a physical mixture with at least recycled polymeric material, and
wherein the recycled polymeric material comprises one or more of the following polymers: polyethylene, polypropylene, polystyrene, polyethylene terephthalate, acrylonitrile-butadiene-styrene, and polyamide.

14. The method of claim 2, wherein the at least one multilayer material comprising the polyethylene and the metallic aluminum is obtained from recycling treatment of post-consumer wastes of beverage cartons and/or scraps from a beverage carton production process.

15. The method of claim 1, wherein the metallurgical furnace is selected from: electric arc furnace, basic oxygen furnace (BOF), converter furnace, and blast furnace.

16. The method of claim 1, wherein the metallurgical furnace is an electric arc furnace, and
wherein the feeding into the metallurgical furnace of the at least one granular composite material comprises dispersing the at least one granular composite material in the mass of molten metal in a vicinity of a floating slag layer and/or in the floating slag layer.

17. A method of employing at least one granular composite material that comprises greater than or equal to 50% and less than or equal to 97% by weight of a polymeric component comprising polyethylene, and greater than or equal to 3% and less than or equal to 50% by weight of metallic aluminum, wherein the percentages by weight refer to a total weight of the polymeric component comprising polyethylene and the metallic aluminum in a ferrous alloy production process in a metallurgical furnace, the method comprising:
using the at least one granular composite material as one or more of fuel, reducing agent, foaming slag-forming agent, deoxydizing agent, and recarburizing agent.

18. The method of claim 1, wherein the polymeric component comprising polyethylene is present in the at least one granular composite material in an amount greater than or equal to 75% and less than or equal to 90% by weight with respect to the total weight of the polymeric component comprising polyethylene and the metallic aluminum.

19. The method of claim 1, wherein the at least one granular composite material comprises the metallic aluminum in an amount greater than or equal to 10% and less than or equal to 25% by weight with respect to the total weight of the polymeric component comprising polyethylene and the metallic aluminum.

20. The method of claim 1, wherein the polymeric component comprising polyethylene comprises the polyethylene in an amount greater than or equal to 95% by weight with respect to a weight of the polymeric component comprising polyethylene.
